(19) United States
(12) Patent Application Publication
(10) Pub. No.: US 2014/0100815 A1
(43) Pub. Date: Apr. 10, 2014

(54) METHOD AND APPARATUS FOR BUILDING AND ASSET MANAGEMENT

(71) Applicant: ArchiDATA Inc., Montreal (CA)

(72) Inventor: Dominique DUBUC, Montreal (CA)

(73) Assignee: ArchiDATA Inc., Montreal (CA)

(21) Appl. No.: 13/973,186

(22) Filed: Aug. 22, 2013

Related U.S. Application Data
(60) Provisional application No. 61/712,096, filed on Oct. 10, 2012.

(51) Int. Cl. G01B 21/04

(52) U.S. Cl. CPC G01B 21/04
USPC 702/152; 702/150

(57) ABSTRACT

A global spatial modeling system and architecture are provided. Each of a plurality of georeferenced boxels provides a whole number georeferenced representation of a location on earth. Each georeferenced boxel has a latitude component, a longitude component, and an altitude component, and can be represented by 10-characters using base64 en coding. A plurality of building element components each represent space or equipment in a building, each building element component being associated with one of the plurality of georeferenced boxels. In an implementation, a method is provided of converting a two-dimensional (2D) building model to a three-dimensional (3D) georeferenced building model. In another implementation, a method is provided to creating a selectable, or clickable, 2D plan.

### CROSS-REFERENCE TO RELATED APPLICATIONS

This application claims the benefit of priority of U.S. Provisional Patent Application No. 61/712,096 filed Oct. 10, 2012 which is incorporated herein by reference in its entirety.

### FIELD

The present disclosure relates to building management, including asset management, space management, facilities management, project management and property management, as well as related methods and systems.

### BACKGROUND

As property and asset management becomes more complex, due in part to size and diversity of the portfolio of properties, the use of systems and tools to facilitate management of such assets is increasingly important.

The Integrated Workplace Management System (IWMS) domain has emerged in the early 2000s to provide asset and property managers with interoperability between systems to execute tasks such as property management, facilities and space management and preventive maintenance of equipment and assets.

Current equipment indexing approaches in the IWMS domain manually attach a value to a “location” field, accompanied by a “parent” field to qualify the level in the spatial structure when the equipment is inside a building, or attach a GPS coordinate to an equipment or an asset, when it is located outside of a building (roof or property).

In most cases, the “location” field is the room number and the “parent” field, the floor name. Then, the floor name becomes the “location” field and the building name, its “parent” field. And so on, up to the top of the spatial structure.

However, such a “location” field may need to be manually changed over time due to relocation, renovation, redevelopment, etc. When such changes are not made, or not made in a timely manner, the equipment may remain attached to an obsolete space or is tied to a spatial structure and does not remain accurate over time due to changes. Therefore, the data becomes unreliable.

One of the main problems identified in the IWMS was indexing of equipment that must be managed in a coherent spatial structure. Another problem was that the spatial structure changes over time (relocation, renovation, redevelopment, etc.) and that the equipment remains attached to obsolete spaces.

In the Architecture/Engineering/Construction domain (AEC), BIM (Building Information Modeling) software uses X,Y,Z coordinates relative to an anchor point in the 3D model (0,0,0) to index an equipment, while CAD (Computer Assisted Drafting) software only refers to 2D coordinates (X,Y) relative to a point determined randomly on the plan. In the case of CAD software, the origins of each plan do not always coincide from one floor to another, due to the randomness of their determination (sometimes, the centre of the sheet, and sometimes at the bottom left).

CAD software only re-transcribes construction plans. It is not designed to create databases and is seldom used to position equipment. BIM software, which is only in its infancy, is not yet capable of feeding equipment databases for property management adequately because they are made for design and construction only. Moreover, the users of such software are architects and engineers, and not building operators, which reduces their interest to enter the proper data for each equipment.

These known approaches in the AEC domain also have inconsistent (and often random) anchor points, such that plans using different approaches cannot easily be correlated with one another, and are incompatible with geospatial coordinates.

CAD and BIM software were designed for construction purposes and not for property management. Passing information on spaces and equipment to IWMS software then becomes complex, and even impossible. The incompatibility between these two domains thus prevents any meaningful interoperability between their data.

The Geographic Information System (GIS) domain is beneficial for territory management based on high-precision geospatial coordinates such as latitude, longitude and altitude. The origin of these coordinates is the Equator for latitude, Greenwich for longitude and sea level for altitude, though the concept of sea level is itself variable due to constantly changing levels.

However, GIS solutions are less effective once they have reached the limit of a property, mainly because they do not have the jurisdiction to manage the assets inside a property. Also, this jurisdiction belongs now to the IWMS domain which will struggle for its exclusivity.

There is also an incompatibility between the geospatial coordinates (which are angles or radians) and the 2D or 3D Cartesian coordinates (which are vectors and distances). The passage between the two types of coordinates thus requires constant data conversion, which involves calculations including the center of the earth. Thus, no extrapolation of distance between two geospatial coordinates can be achieved without a series of complex trigonometric calculations.

Moreover, the data in the GIS domain is too detailed to be combined adequately with data from construction plans or equipment databases. Coordination between GIS systems (very precise) and IWMS systems (very approximate) becomes almost impossible.

Known approaches do not achieve the notions of permanence and history of changes, due to the lack of coherence between the equipment positioning systems and the spatial updates. These updates are produced by the creation of architectural or engineering plans (CAD), or very recently by the creation of BIM models.

It is, therefore, desirable to provide a method and apparatus for building and asset management that reduces or removes at least one disadvantage of known approaches.

### BRIEF DESCRIPTION OF THE FIGURES

Embodiments of the present disclosure will now be described, by way of example only, with reference to the attached Figures.

FIG. 1 illustrates a global spatial georeferenced system for building and infrastructure according to an embodiment of the present disclosure.

FIG. 2A and FIG. 2B illustrate the creation of a floor zone in a 2D CAD drawing and the positioning of this floor zone in a 3D model according to embodiments of the present disclosure.

FIG. 3A and FIG. 3B illustrate the adjusting of floor zones in a 3D model and its positioning on an interactive mapping system according to embodiments of the present disclosure.

FIG. 4A and FIG. 4B illustrate the creation of a 3D matrix and the positioning of the North for this 3D model according to embodiments of the present disclosure.

FIG. 5A and FIG. 5B illustrate the creation of a boxel grid in a 3D model and the identification of the boxels for each space or equipment position according to an embodiment of the present disclosure.

FIG. 6 illustrates the selection of a specific space, such as a room, in a CAD 2D drawing according to an embodiment of the present disclosure.

FIG. 7A and FIG. 7B illustrate the transposition of a boxel array in a 2D CAD drawing and the calculation of the list of boxels in a 3D model for a specific space according to an embodiment of the present disclosure.

FIG. 8 illustrates the creation of a view on a specific space for mapping on a 2D CAD drawing according to an embodiment of the present disclosure.

FIG. 9A and FIG. 9B illustrate the identification of a list of boxels touched by a selected view of a space and the creation of the mapping in pixels on an image in jpeg of this specific view according to an embodiment of the present disclosure.

FIG. 10 illustrates a screen capture of a HTML page representing the clickable area mapped on a specific view, such as a JPEG, according to an embodiment of the present disclosure.

### DETAILED DESCRIPTION

An embodiment of the present disclosure provides a global spatial georeferenced system for building and infrastructure comprising a processor and one or more non-transitory computer-readable media storing a database. The database includes georeferenced boxels and building element components. Each georeferenced boxel provides a whole number georeferenced representation of a location on earth, and includes latitude data, longitude data, and altitude data. Each building element component represents space or equipment in a building and includes boxel association data associating the building element with one of the boxels. In an implementation, the database comprises all the GIS footprints of all the spaces and equipment in a building, on a building or on a site stored in several databases. In information technology, a 3D cubic pixel is called a BOXEL. In an embodiment of the present disclosure, an equipment item in a building would be linked to only one georeferenced boxel (longitude, latitude and altitude), regardless of the time and the space where it is located.

In an embodiment, the present disclosure provides a global spatial georeferenced system for building and infrastructure comprising a processor and one or more non-transitory computer-readable media storing a database. The database includes a plurality of georeferenced boxels and a plurality of building element components. Each of the plurality of georeferenced boxels provides a whole number georeferenced representation of a location on earth. Each georeferenced boxel has latitude data, longitude data, and altitude data. The plurality of building element components represent space or equipment in a building. Each building element component has boxel association data associating the building element with one of the plurality of georeferenced boxels.

In an example embodiment, each of the plurality of georeferenced boxels represents exactly 1/10 of a second in a degree-minute-second geographical coordinate system. In an example embodiment, each of the plurality of georeferenced boxels comprises a cubic unit of about 10 feet by 10 feet by 10 feet (about 3 meters by 3 meters by 3 meters).

In an example embodiment, each of the plurality of georeferenced boxels is represented by 10-characters using base64 encoding.

In an example embodiment, the altitude component comprises an absolute altitude with respect to a ground floor of a building. In an example embodiment, the altitude component comprises a relative altitude which attaches a selected georeferenced boxel to a building floor on which the selected boxel is located.

In an example embodiment, a selected building element component is associated with each georeferenced boxel in which at least one portion of the building element is located, up to a maximum of eight adjacent georeferenced boxels each sharing a common point of intersection.

In an example embodiment, the association of a selected building element with one of the plurality of georeferenced boxels is time invariant. In an example embodiment, the association of a selected building element with one of the plurality of georeferenced boxels is invariant with respect to floor layout alteration.

In an embodiment, the present disclosure provides a method of converting a two-dimensional (2D) building model to a three-dimensional (3D) georeferenced building model, comprising: creating a 3D model by superimposing and stacking floor part perimeters of the 2D building model and adjusting building height; determining a geographical position of the building represented by the 2D building model by obtaining georeferenced data corresponding to the building; determining a global positioning system (GPS) coordinate corresponding to a selected point on the building; extracting a transformation matrix to correlate the 2D building plan with the 3D model; and determining a universal georeferenced representation of each element on the 2D plan based on the transformation matrix and on known information on relative position to the selected point on the building.

In another embodiment, the present disclosure provides a method of converting a two-dimensional (2D) building model having 2D building plans to a three-dimensional (3D) georeferenced building model, comprising: determining a transformation matrix to correlate the 2D building plans with the 3D model; and determining a global georeferenced representation of each element on the 2D plan based on the transformation matrix and on known information on relative position to a selected point on the building.

In an example embodiment, the method further comprises: superimposing and stacking floor part perimeters of the 2D building model and adjusting building height; determining a geographical position of the building represented by the 2D building model by obtaining georeferenced data corresponding to the building; determining a global positioning system (GPS) coordinate corresponding to the selected point on the building.

In an example embodiment, the method further comprises: determining an associated boxel for a building element by transposing one of the vertices of the 2D plan to the 3D model using the transformation matrix; and finding the equivalent of each 3D point in georeferenced coordinates by means of Haversine formulas. In an example embodiment, the method further comprises creating a selectable plan by: calculating the 4 edges and center of each boxel in the georeferenced environment; converting the calculated boxel data into 3D data and 2D coordinates; obtaining a bitmap image of a 2D plan and extrapolating each boxel edge to bitmap coordinates; assigning a hyperlink to an area of the bitmap image corresponding to each boxel.

In an example embodiment, the present disclosure provides a computer-readable memory storing a global spatial georeferenced database for building and infrastructure comprising a plurality of georeferenced boxels, and a plurality of building element components as described and illustrated herein.

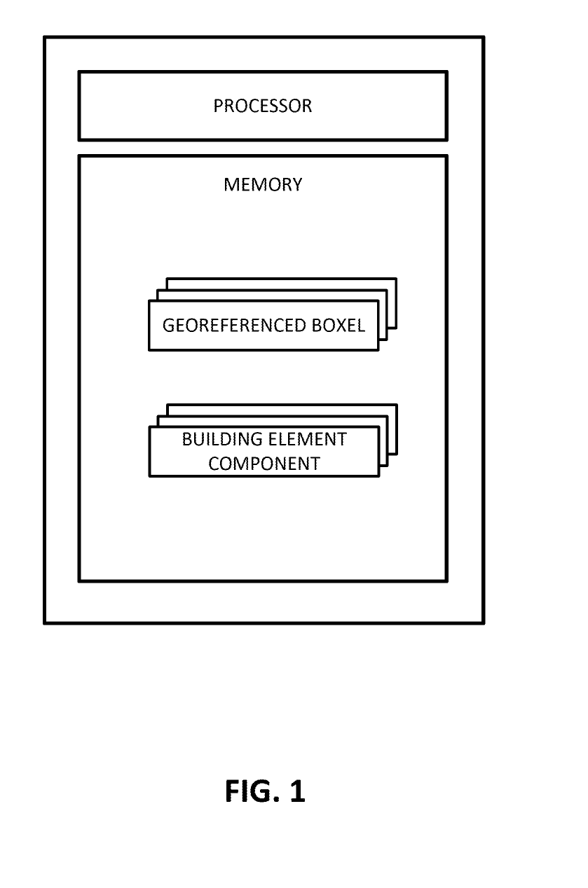

FIG. 1 is a block diagram illustrating a global spatial georeferenced system for building and infrastructure according to an embodiment of the present disclosure. The system comprises a processor and a computer-readable memory. The memory stores a database including a plurality of georeferenced boxels, and a plurality of building element components. Each of the plurality of georeferenced boxels provides a whole number georeferenced representation of a location on earth. Each georeferenced boxel has latitude data, longitude data, and altitude data. The plurality of building element components represent space or equipment in a building. Each building element component has boxel association data associating the building element with one of the plurality of georeferenced boxels.

Example embodiments of the present disclosure use a cubic module of approximately 3 meters (≈10′), because it represents exactly 1/10 of a second (degree-minute-second) in longitude at the Equator and because 3 meters is also the average height of a storey in a building.

In an embodiment, each of a plurality of boxels provides a georeferenced location on earth represented by a set of whole numbers. The embodiments of the present disclosure operate in whole numbers instead of in fractions of degrees (GPS coordinates). In this way, each footprint would be calculated from one coordinate (longitude-latitude-altitude), rounded to the nearest module, to another coordinate in order to define a cubic parallelepiped in planetary space.

The databases produced by the embodiments of the present disclosure comprise the geospatial footprint of each space inventoried, such as the floors, the rooms and the project zones. A geospatial footprint is the trace on the ground occupied by a plane or a space, accompanied by its vertical altitude. Each geospatial footprint is represented by a list of georeferenced boxels linked to a floor level or an altitude.

Each georeferenced boxel has a latitude component, a longitude component, and an altitude component, and can be represented by 10 characters using a base64 encoding protocol.

In an implementation, a method is provided of converting a two-dimensional (2D) floor plan to a three-dimensional (3D) georeferenced building model. In another implementation, a method is provided to create a clickable 2D image, such as a jpeg file with mapping.

Embodiments of the present disclosure solve one or more of the problems of known approaches by providing at least one of the following features: identification of the location of a space or equipment with a permanent code that is independent of the spatial structure which can change in time; transposition of the spatial structure into a georeferenced space; and optimization of the search engines for georeferenced databases.

Other aspects and features of the present disclosure will become apparent to those ordinarily skilled in the art upon review of the following description of specific embodiments in conjunction with the accompanying figures.

In an embodiment, each of the plurality of georeferenced boxels provides a georeferenced representation of a location on earth in whole numbers. In an embodiment, to run searches more quickly, the georeferenced boxel is provided as a fixed module that enables operations using whole numbers instead of in fractions of degrees (GPS coordinates). In this way, each footprint can be calculated from one coordinate (longitude-latitude-altitude), rounded to the nearest module, to another coordinate in order to define a cubic parallelepiped in planetary space.

Since the use of GPS systems is not possible inside a building, the use of boxels extrapolated from geospatial data allows property managers to locate georeferenced spaces and equipment. In an embodiment, the geospatial data is rounded to human scale, such as +/−3 meters (≈10 ft).

In an example embodiment, the georeferenced boxel comprises a cubic module of 3.08 meters (≈10 ft) by 2.16 meter (≈7′). In such an example embodiment, the georeferenced boxel represents exactly 1/10 of a second (degree-minute-second) in longitude at the Equator. Three meters is also the average height of a storey in a building.

An example embodiment will now be considered in detail, in which a georeferenced matrix is based on boxels in whole numbers, which contains all the plans and spaces. Since the maximum number of boxels required to go around the planet is only 12,960,000 (360°×60′×60″×10) times 0.1 second, any value can be encoded within 0 to 2²⁴ (0 to 16,777,215).

A number lower than 2²⁴ (or 24 bits) can be coded in 4 characters if one applies the base64 coding used to code the GUID (Global Unique Identifier) in the BIM/IFC (Industrial Foundation Classes) files. Thus, the longitude and latitude in boxels can be coded in 4 characters+4 characters, or 8 characters.

The list of standard characters for 0 to 63 is: 0123456789ABCDEFGHIJKLMNOPQRSTUVWXYZabcdefghijklmnopqrstuvwxyz_$

With respect to altitude, embodiments of the present disclosure recognize that the notion of sea level is not constant everywhere on the planet, and may be subject to change over time. Accordingly, embodiments of the present disclosure provide: a relative altitude model, which attaches the boxel to the floor on which it is located; and an absolute altitude model, which allows coding of altitude in terms of the ground floor level.

Therefore, for each building, the declared ground floor level is the “00” level and one boxel is added for each 3 m (≈10 ft) of elevation. With two characters in base64, it is possible to code the equivalent of 640 floors 3 m high. In an example embodiment, the floors above the ground floor are coded by a number (from 00 to 99). Above 99, their code can include lower-case letters (from a0 to z9) for 260 additional floors, for a total of 360 floors above ground. The basements can have a code including an upper-case letter (from A0 to Z9) for a total of 240 basements.

In the case of a boxel relative to a floor, the value “$$” is used in an embodiment to indicate that this is an altitude relative to the official level of the floor built.

In short, a coordinate in Georeferenced Boxels would only take 10 characters of base64 encoding to render it unique on the planet. For example, the boxel corresponding to the GPS coordinate 45° 29′46.90″N-73° 35′19.50″W would be “IcujdLIL$$” if it is relative and “IcujdLIL00” if it is located on the ground floor slab.

Table 1 below is a recapitulative table showing the calculation of the exemplary 10-character georeferenced boxel representation:

TABLE 1

| | | | Whole | Base64 |
|---|---|---|---|---|
| Types | Coordinates | Fraction | Boxel | Boxel |
| Latitude | 45° 29′46.90″N | 45.496361° | 4877869 | Icuj |
| Longitude | 73° 35′19.50″W | 286.411250° | 10310805 | dLIL |
| Altitude | | 35342 mm | 11 | 11 |
| | | | | IcujdLIL11 |

In an embodiment, to each boxel identified in this manner in the database is assigned a series of: planar elements (such as spaces), linear elements (such as special networks or piping), or punctual elements (such as equipment).

In an implementation, each element associated with a boxel has a hyperlink pointing to a pivot page, which is found on a space or inventory web server. Each pivot page in return offers a series of hyperlinks pointing to other systems or other modules (e.g. document management).

According to embodiments of the present disclosure, by using georeferenced boxels it is possible to produce a spatial coding with a ten-character code to locate an equipment within a building, on a building or on a site, regardless of the room number (if available) it is associated with.

In this manner, a method and apparatus according to an embodiment of the present disclosure makes it possible to find equipment by its geospatial location and reassign it a space corresponding to the new spatial structure (building-floor-room). It is then possible to produce a history of changes independent of new floor layouts.

In an example embodiment, the association of a selected building element with one of the plurality of georeferenced boxels is time invariant. In an example embodiment, the association of a selected building element with one of the plurality of georeferenced boxels is invariant with respect to floor layout alteration. In an illustrative example, the association of a selected building element with a georeferenced boxel does not change over time, nor does it change as a result of an alteration of the layout of the floor.

Turning to another aspect, according to another embodiment, the present disclosure provides a method of converting CAD (AutoCAD) plans or TIF and PDF (scanned) plans into a Georeferenced Boxel matrix. Such a method is valuable, since about 95% of the current real estate inventory is in one of these formats (CAD, TIF or PDF). Rather than wait for the advent of BIM, which could take another 15 to 20 years before it is equivalent to the pool of AutoCAD drawings already produced, an approach according to an embodiment of the present disclosure comprises creating parallel environments where each coordinate has all the values coming from each distinct environment.

Table 2 provides information regarding the data environments that are considered according to an embodiment of the present disclosure.

TABLE 2

| Data | | | | |
|---|---|---|---|---|
| Environment | Data Type | Values | Origin | Orientation |
| 2D plan | 2D | X, Y | Random | Random |
| (AutoCAD | | | | |
| or Scanned) | | | | |
| 3D model | 3D | X, Y, Z | Survey point | True North |
| (AutoCAD | | | | |
| or BIM) | | | | |
| GoogleEarth | Geospatial | Degrees or | Greenwich and | N/A |
| model | | radians | the Equator | |
| HTML page | Pixels | Height, width | Upper left- | Random |
| (Bitmap) | | | hand corner | |

According to embodiments of the present disclosure, obtaining a correspondence between the different data environments includes creating a transformation matrix. In an example embodiment, the creation of the transformation matrix comprises the following actions:

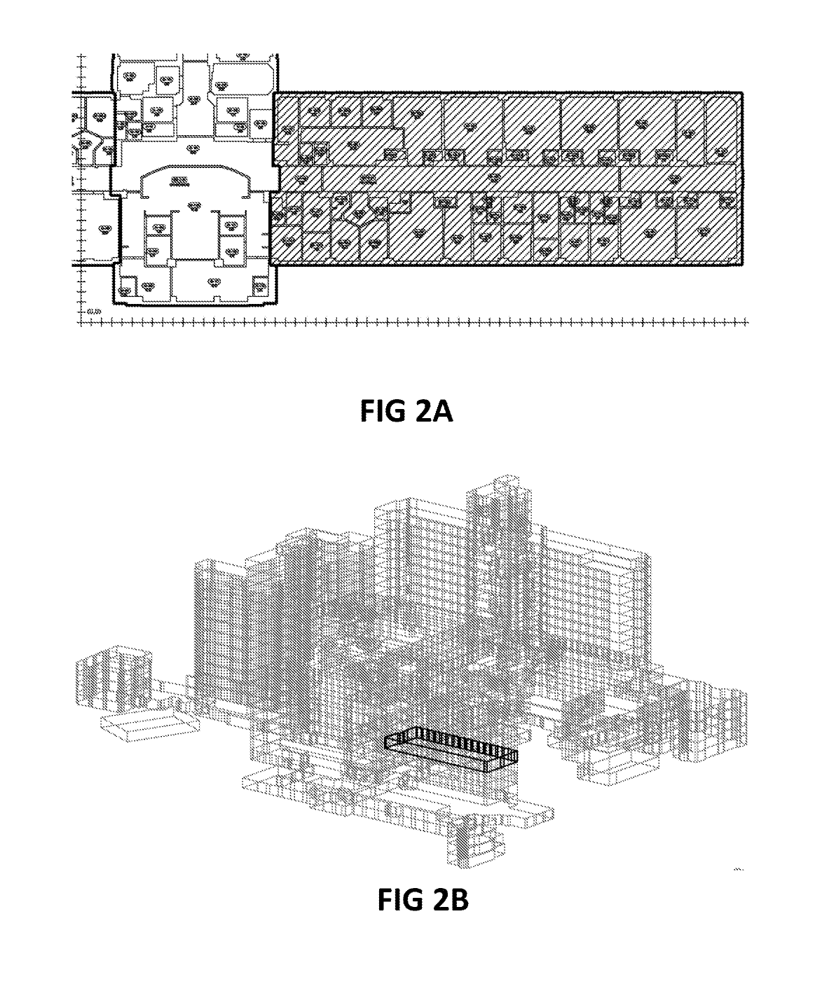

1) Drawing the perimeter of each floor part in the AutoCAD 2D plans. An example of a floor part, or floor zone, created in a CAD 2D drawing according to an embodiment of the present disclosure is shown in FIG. 2A.

2) Importing all the floor part perimeters to the same AutoCAD 3D model. An example of a selected floor zone, among a plurality of floor zones, imported into the same 3D model according to an embodiment of the present disclosure is shown in FIG. 2B.

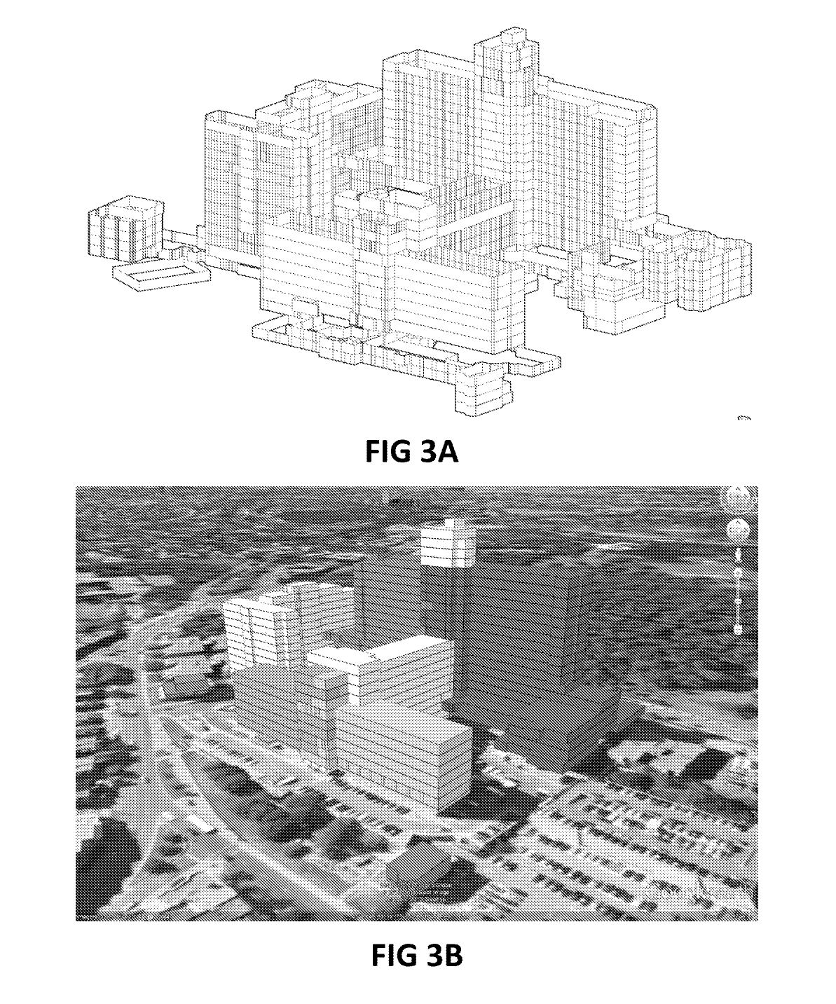

4) Superimposing each floor part perimeter of the same building at the right height, according to their floor ranking. An example of adjusting floor zones in a 3D model according to an embodiment of the present disclosure is shown in FIG. 3A.

5) Importing an interactive mapping (e.g. GoogleEarth) map segment corresponding to the building site to the AutoCAD 3D model. An example of positioning a 3D model on an interactive map according to an embodiment of the present disclosure is shown in FIG. 3B.

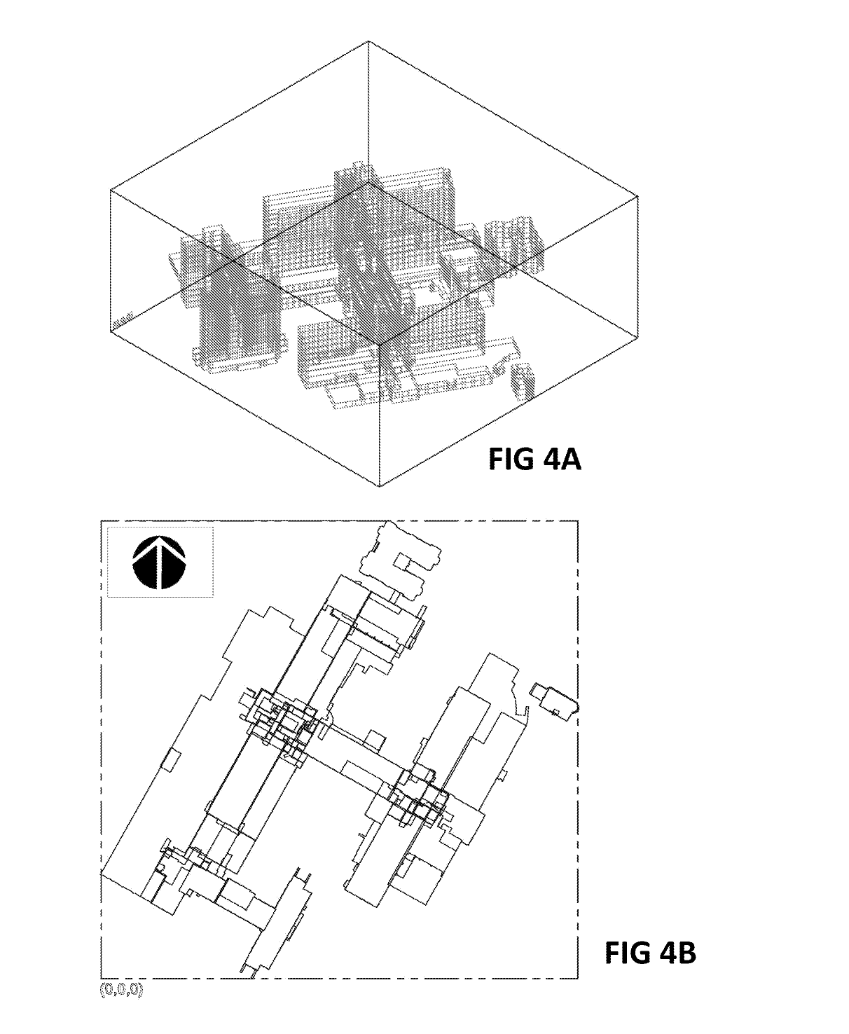

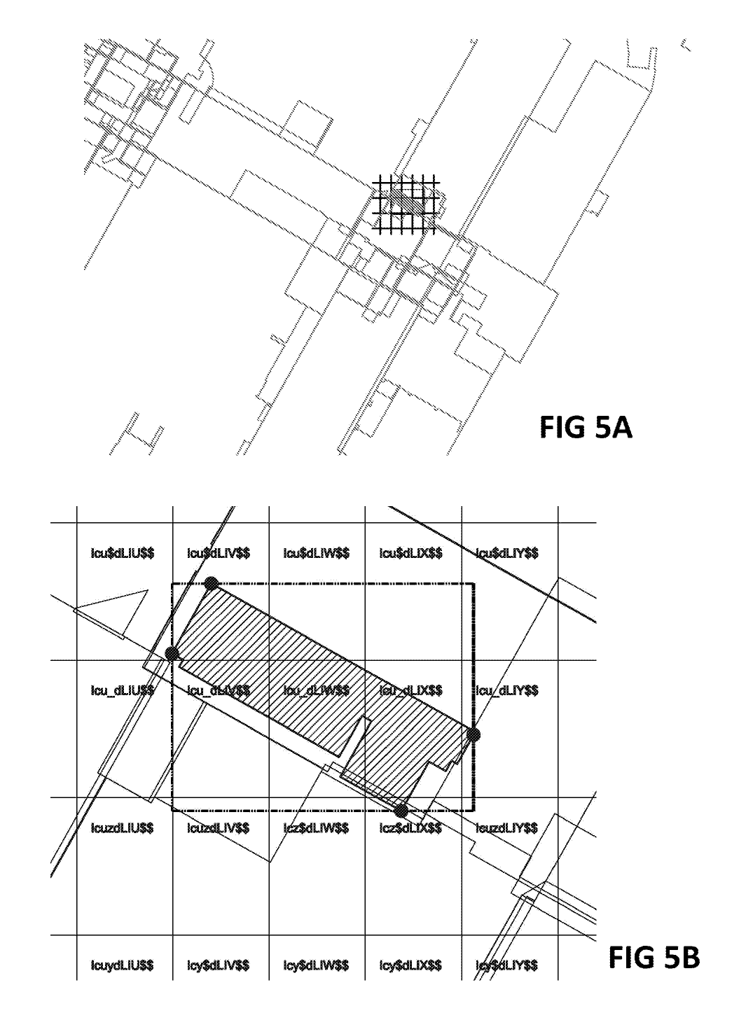

6) Positioning and orienting each stack of floor part perimeters corresponding to a building on its trace on the ground in the AutoCAD 3D model. An example of creation of a 3D matrix comprising a plurality of stacked floor part perimeters of a building is shown in FIG. 4A. The positioning and orientation on the ground of such a 3D matrix is shown in FIG. 4B, which can be described as positioning of the north in a 3D model. FIG. 5A and FIG. 5B illustrate the creation of a boxel grid in a 3D model and the identification of the boxels for each space or equipment position according to an embodiment of the present disclosure.

7) Adjusting the floor heights and the building heights in relation to each other in the AutoCAD 3D model.

8) Extracting the transformation matrix applied to each floor part perimeter that makes the correlation between the 2D plan and the 3D model (X,Y,Z translation and rotation).

Table 3 provides an example of a transformation matrix of one building of a plurality of buildings in a complex according to an embodiment of the present disclosure.

| | | Ele- | | | |
|---|---|---|---|---|---|
| FloorName | PartofFloor | vation | Origin_x | Origin_y | Azimuth |
| HGM-C-01 | 1OF1 | 7200 | 55817.5 | −166240 | 60.64 |
| HGM-C-02 | 1OF1 | 11500 | 55817.5 | −166240 | 60.64 |
| HGM-C-03 | 1OF1 | 15450 | 55817.5 | −166240 | 60.64 |
| HGM-C-04 | 1OF1 | 19390 | 55817.5 | −166240 | 60.64 |
| HGM-C-05 | 1OF1 | 23330 | 146708 | −140361 | 95.44 |
| HGM-C-06 | 1OF1 | 27270 | 55817.4 | −166240 | 60.64 |
| HGM-C-07 | 1OF1 | 31570 | 55817.5 | −166240 | 60.64 |
| HGM-C-08 | 1OF1 | 35870 | 55817.5 | −166240 | 60.64 |
| HGM-C-09 | 1OF1 | 39900 | 55817.5 | −166240 | 60.64 |
| HGM-C-10 | 1OF1 | 43400 | 60517.5 | −157886 | 60.64 |
| HGM-C-11 | 2OF2 | 49790 | 66067.5 | −160267 | 60.64 |
| HGM-C-11 | 1OF2 | 46900 | 55817.5 | −166240 | 60.64 |
| HGM-C-20 | 1OF1 | 78350 | 55817.5 | −166240 | 60.64 |
| HGM-C-21 | 1OF2 | 83810 | 55817.5 | −166240 | 60.64 |
| HGM-C-21 | 2OF2 | 85813 | 66245 | −160757 | 60.64 |
| HGM-C-22 | 1OF1 | 87560 | 55817.5 | −166240 | 60.64 |
| HGM-C-23 | 1OF1 | 91280 | 55817.5 | −166240 | 60.64 |
| HGM-C-24 | 1OF1 | 95000 | 55817.7 | −166240 | 60.64 |
| HGM-C-S1 | 1OF1 | 3600 | 55817.5 | −166240 | 60.64 |

Once the transformation matrix of each floor is determined or recovered, it is possible to establish the correspondence between the coordinates of a 2D plan positioned and oriented at random in the space and the georeferenced coordinates, based on knowing a common point between the 3D model and a GPS coordinate.

To do this, a point of the known model (such as the corner of a building) is selected, along with the GPS equivalent (measured on site or using GIS software such as GoogleEarth) of the selected point. From there, it is possible to determine or calculate the equivalent in 3D coordinates and in georeferenced coordinates of each point of the 2D plan by complex trigonometric calculations.

To determine the boxel of an equipment or the list of boxels of a zone according to an embodiment of the present disclosure, first transpose the origin of the object or one of the vertices of the zone from the 2D plan to the 3D model by using the conversion matrix. Then, find the equivalent of each 3D point in georeferenced coordinates, such as by using the “Haversine” formula.

Once each georeferenced coordinate is found, round it to the closest 1/10 of a second to obtain its equivalent in boxels. Then, convert the longitude and latitude coordinates into whole numbers, and then into base64 codification.

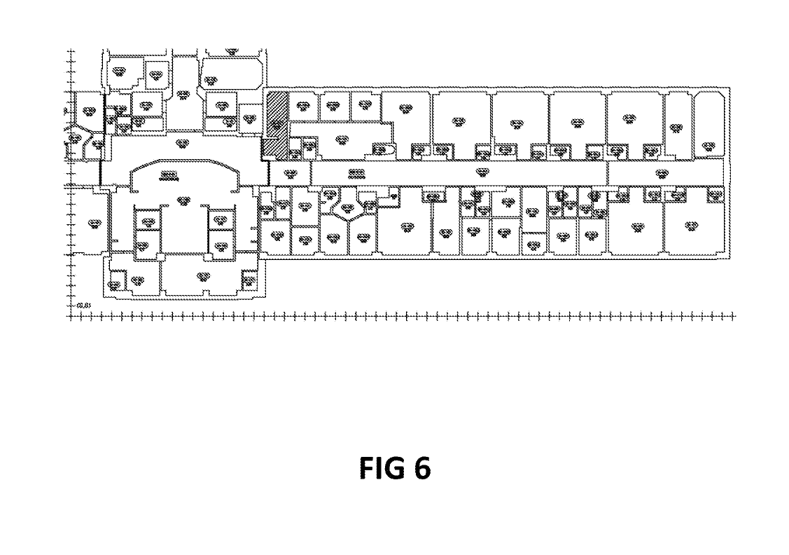

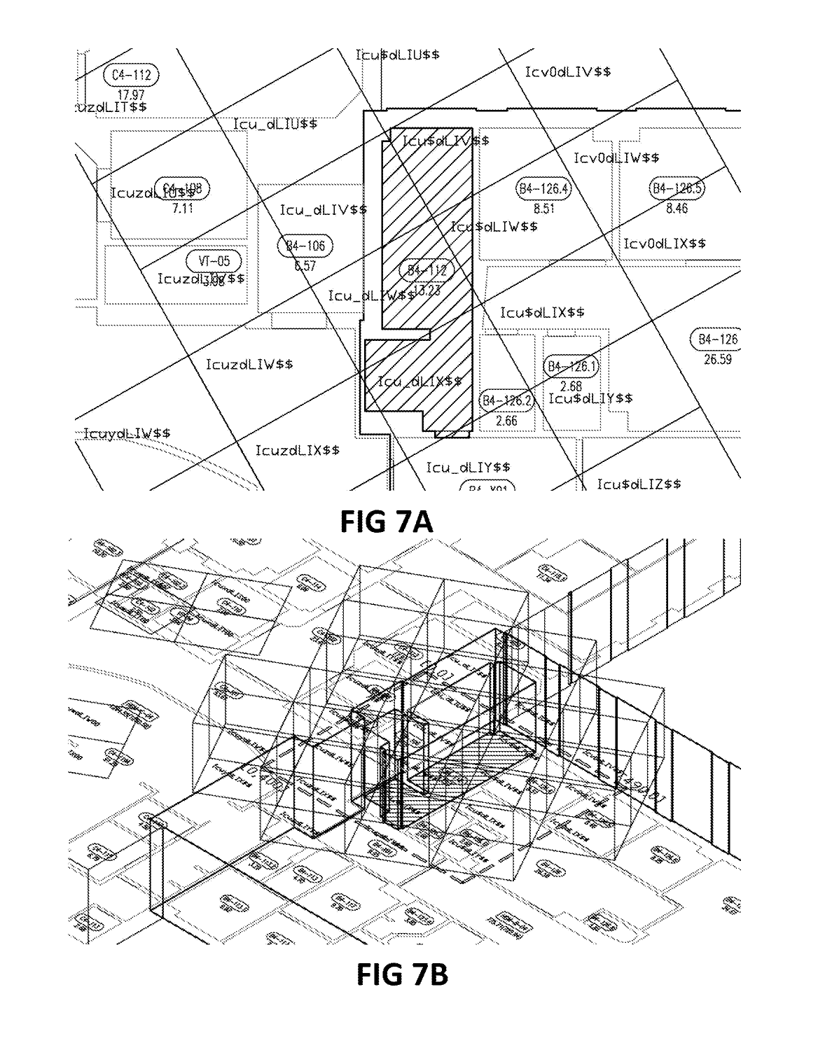

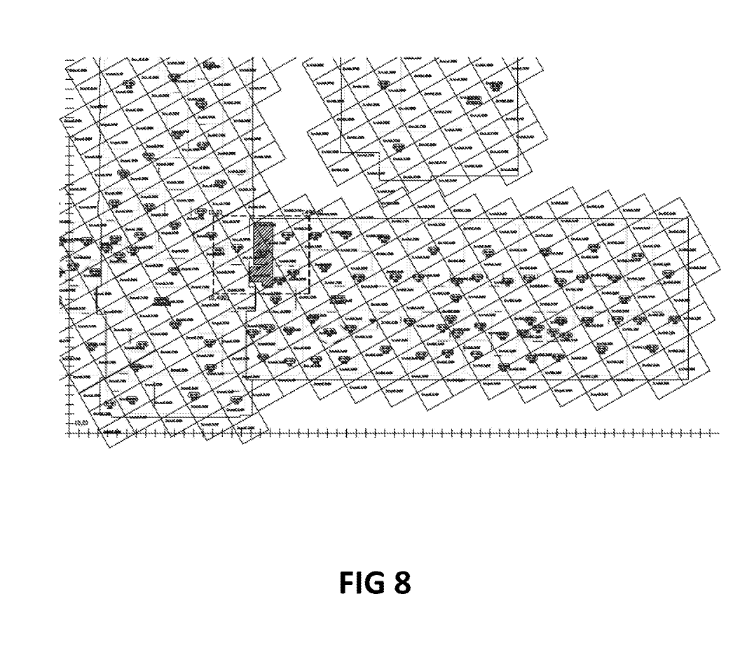

In relation to the above-described aspects, FIG. 6 illustrates the selection of a specific space, such as a room, in a CAD 2D drawing according to an embodiment of the present disclosure. FIG. 7A and FIG. 7B then illustrate the transposition of a boxel array in a 2D CAD drawing and the calculation of the list of boxels in a 3D model for a specific space according to an embodiment of the present disclosure. Subsequently, FIG. 8 illustrates the creation of a view on a specific space for mapping on a 2D CAD drawing according to an embodiment of the present disclosure.

Finally, in another aspect and according to another embodiment, a method of creating a clickable image of a 2D plan is provided, such as for use on a tablet computing device, or any other computing device with a touch-sensitive screen. The term “click” refers to any act of selecting, by click, touch, gesture or any other means of selection, or any combination thereof. The term “clickable” similarly refers to selectable by such acts. In order to be able to click on, or otherwise select, an image of a plan on an HTML page to access the boxel page, the 4 edges and the centre (control point) of each boxel are calculated in the georeferenced environment, and then converted into 3D data (using “Haversine” formula) and 2D coordinates (using the transformation matrix).

The contour of the zoom executed in the 2D plan is also used to obtain the bitmap image of this view in JPEG and to extrapolate each boxel edge to bitmap coordinates (origin 0.0 at the top left of the jpeg view). This way, a clickable mapping of the boxel list is obtained in the bitmap view of the page representing a 2D plan. The hyperlink of each rectangle of the image grid then points to the georeferenced boxel corresponding to the space bounded by the boxel.

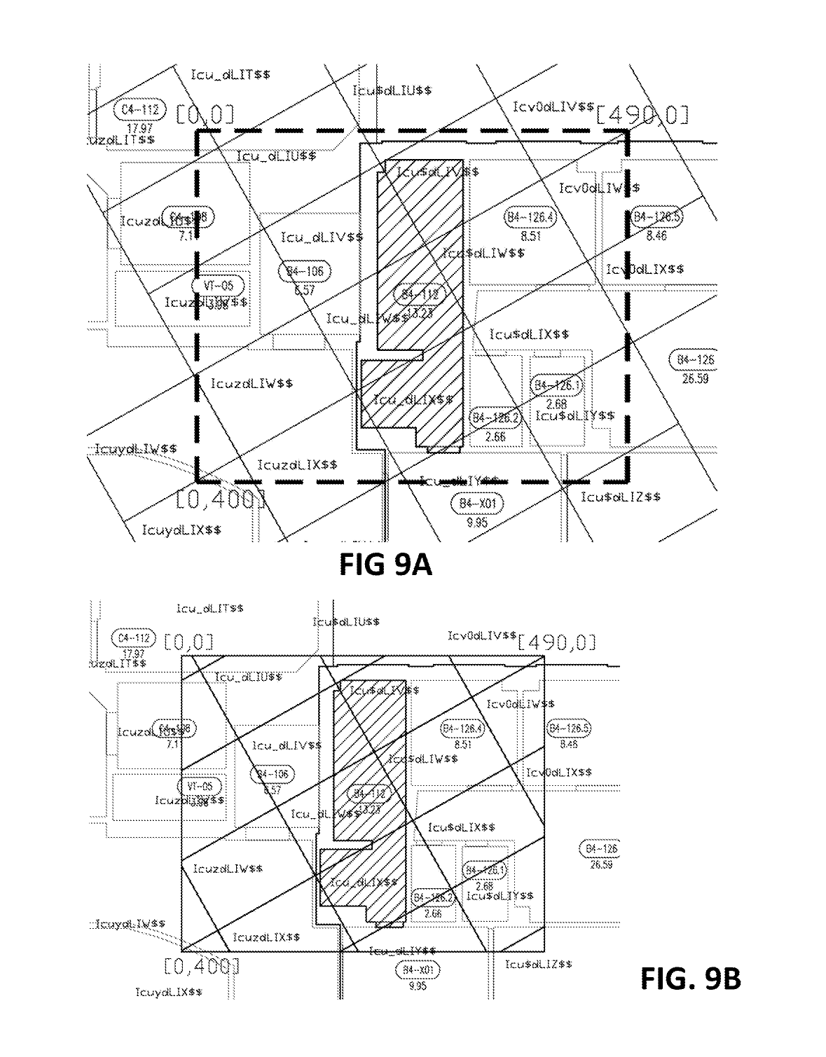

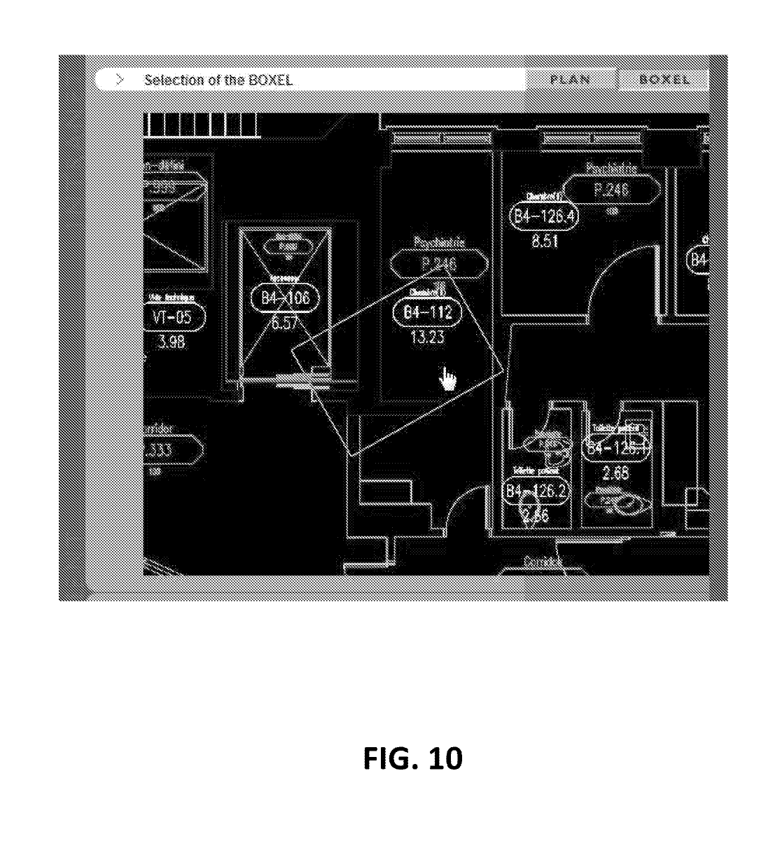

In relation to the above-described aspect, FIG. 9A and FIG. 9B illustrate the identification of a list of boxels touched by a selected view of a space and the creation of the mapping in pixels on an image in jpeg of this specific view according to an embodiment of the present disclosure. FIG. 10 illustrates a screen capture of a HTML page representing the clickable area mapped on a specific view, such as a JPEG, according to an embodiment of the present disclosure.

An approach according to an embodiment of the present disclosure thus makes it possible to select any position of an equipment in an AutoCAD plan (with its origin) or those of the vertices of a spatial zone (floor, room or project) and “georeference” them on the planet, by using a concept of whole-number boxels. The principle of whole-number coordinates accelerates the search in the relational databases and will allow the extension of this concept on a larger scale (in the order of one billion records).

This conversion method simplifies the spatial coding by reducing all types of coordinates (2D, 3D, Bitmap, GPS) to a single 10-character code. Thus, the elements can be transposed from one data platform to another, regardless of the type of data environment used or the spatial structure in effect.

This simplification of the equipment's spatial positioning also reduces update errors by making it possible to find the equipment in the space, even if the unique identification keys are missing or wrong. This will allow the creation of a history of changes of the spaces and equipment spread over various projects originating from different computer platforms (CAD, BIM, GIS or IWMS).

Finally, the use of georeferenced boxels on the Web will make it possible to simplify consultation of space, document and equipment inventories by providing a simple method to the user (find the right floor and click on the plan view) to do complex searches on the space. In another example embodiment, a search engine with three-level hierarchy is provided: the boxels affected by the query, the pivot pages in a primary set of servers, and other links to other systems.

Embodiments of the present disclosure as described and illustrated herein address the problem of “geolocation” inside a building by an approach that combines GIS and AEC domains. This double-headed approach is superior to those of other sectors that are limited to their area of expertise. Here are the difficulties encountered by the other related areas:

GIS software stops at the property line and has absolutely nothing to do with the inside of a building. They thus do not really have solutions to offer in this sector. Embodiments of the present disclosure applied to GIS property management are therefore superior to what is offered by the software in this sector.

As for GPS and surveying, it is very difficult for satellites to see inside buildings and reading GPS surveys is almost impossible. “Georeferencing” thus can only be done by extrapolation of geospatial coordinates from a cartesian coordinate model (X,Y,Z). Surveyors have much more precise tools to conduct their surveys inside buildings, but these surveys are not always georeferenced. Regardless of whether it is in 2D (laser surveys) or 3D (point clouds), the result produces 2D or 3D drawings, often in non-georeferenced AutoCAD format. Embodiments of the present disclosure allow to “georeference” all the surveys produced in AutoCAD format.

With IWMS software, the way equipment is referenced is limited to assigning it to a location that may or may not have an association with another location. The reliability of this information then becomes doubtful and adapts poorly to updates. Embodiments of the present disclosure thus was developed specifically to improve software performance in this field by allowing access to a better location reference for equipment and the spaces where it is found.

With BIM software, projects are produced within an autonomous 3D (X,Y,Z) model. Embodiments of the present disclosure accelerate the “geolocation” process of 3D models by allowing the creation of such models directly from AutoCAD 2D drawings instead of waiting for them to be produced by projects in BIM mode.

With interactive mapping systems (such as GoogleMaps, Bing or MapQuest), the embodiments of the present disclosure are faster to implement than the existing approaches and to obtain information inside buildings. In some cases, companies ask citizens to provide them with CAD plans of the ground floors of buildings that they subsequently map manually in order to extend their navigation system into buildings. Since this is a “one shot” operation and buildings change constantly, their surveys will quickly become obsolete, as in the case of IWMS. Embodiments of the present disclosure are superior to existing approaches because they account for the latest surveys updated by the organizations themselves, which then are converted automatically into geospatial data and not into static data entered by hand.

In known approaches, there are no references to developments using the boxel concept (which comes from the medical imaging field) in GIS. Indeed, since the GIS domain is seeking to become more and more precise, nobody has thought of producing a less efficient standard, such as the boxel, than the standards in effect at this time (precision of around ±3 m for standard GPS to ±3 mm for surveyors and the Army).

One implementation of the solution proposed in the various embodiments of the present disclosure is to create an intermediate GIS module that allows to qualify both modern GIS data (precise to around one millimeter) and data coming from GPS or another system (precise to around one meter), as well as extra-precise data coming from CAD or BIM, or even worse, extracted from scanned paper plans.

By using the georeferenced boxels, it will also be possible to reconcile spatial reference data for equipment that would not be attached to a well-established spatial structure (such as floors and rooms), because this equipment is located on a site or on a roof (such as chillers on a roof or a manhole in a field). In addition, the georeferenced boxel allows equipment or locations to be attached to a coordinate that will not change over time (as opposed as a room number, which can change due to remodeling). On the contrary, the boxel-equipment association will allow the creation of a history of the changes of room of the equipment has undergone during a building's life cycle. This history will provide a bridge between the different IWMS that could have information on this equipment or the space where it is located.

In a first embodiment (development mode), this patent application allows pooling of disparate elements coming from fragmentary databases and render then to a human scale for a user who may very well be satisfied with precision of 3 m (such as finding a chiller on the roof or locating equipment in a building).

In a second embodiment (development mode), this patent application allows encoding of equipment locations or spaces in boxels, directly from the AutoCAD 2D plans produced in the past 25 years or more.

In an embodiment (for example), this patent application then allows organizations to convert their AutoCAD drawing inventories automatically into a georeferenced 3D database without having to wait for re-transcription of the readings contained in these inventories into another technology (such as BIM or GIS), which is likely to take another 25 years.

Moreover, due to the impossibility of taking precise GPS readings inside buildings, the embodiments of the present disclosure allow a virtual GPS environment to be recreated, based on measurements taken outside the building. Therefore, each equipment location or each positioning in a space inside a building can be converted into georeferenced coordinates. It will be possible to make the connection between a room and other positioning systems, such as cellular antennas, RFS (Radio Frequency Systems), or even Wi-Fi.

In a third embodiment (development mode), this patent application allows to transpose the list of georeferenced boxels resulting from calculation of the coordinates between the 2D plan, the 3D model and the earth to a clickable plan on a smart tablet or device.

For example, this patent application allows transposing the georeferenced coordinates to an html mapping superimposed on a .jpg image representing the plan of a space or the location of equipment. For example, this transposition of latitude-longitude (which are angles in degrees) is first done to cartesian coordinates (x,y) relative to a plan sheet (AutoCAD drawings) and then to a bitmap matrix relative to the view of the image in .jpg (pixels in width and height).

With this transposition, a user, in a completely transparent manner, can display the image of a building plan or a room plan and click it to be redirected to the georeferenced boxel page corresponding to his click. By clicking a precise point, regardless of the jpeg view he will have chosen to click, the user will end up on the same page corresponding to the boxel as if he clicked on the same location or the same equipment in each view.

By creating a planetary database composed of the GIS footprint of each space and location of equipment of a building, embodiments of the present disclosure can be linked to search engines to offer a complete corporate solution for asset management and property management.

In addition, these companies (search engines) operate interactive mapping systems that will also be able to benefit from data coming from a georeferenced database inside the buildings according to an embodiment of the present disclosure. Once the freshness of their initial data has lost its edge, such companies will look to other, less costly sources like ours.

By becoming the core of building information, data produced by embodiments of the present disclosure can be sold to IWMS and FM (Facilities Management) software to reduce their implementation costs (which are exorbitant) as well as updates costs following new floor layouts.

Another field for examples of this patent application is geolocation. GPS companies increasingly will need data from inside buildings, particularly for public safety in case of attempted hostage takings, shootings or any other acts of terrorism.

Being able to find someone in the room where he is located by the signal he emits (Radio Frequency, Wi-Fi or cellular) will be one of the research areas in which the embodiments of the present disclosure are likely to make the most progress.

Due to the limitations of GPS satellites and the very frequent changes of morphology of the spaces inside buildings, very few companies will risk guaranteeing the integrity of their data when a person or equipment has to be geolocated. This is a problem that example embodiments of the present disclosure will solve.

A global spatial modeling system and method are provided. Each of a plurality of georeferenced boxels provides a whole number georeferenced representation of a location on earth. Each georeferenced boxel has a latitude component, a longitude component, and an altitude component, and can be represented by 10-characters using base64 en coding. A plurality of building element components each represent space or equipment in a building, each building element component being associated with one of the plurality of georeferenced boxels. In an implementation, a method is provided of converting a two-dimensional (2D) building model to a three-dimensional (3D) georeferenced building model. In another implementation, a method is provided to creating a selectable, or clickable, 2D plan.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A global spatial georeferenced system for building and infrastructure comprising:
a processor; and
one or more non-transitory computer-readable media storing a database including:
a plurality of georeferenced boxels, each of the plurality of georeferenced boxels providing a whole number georeferenced representation of a location on earth, each georeferenced boxel having latitude data, longitude data, and altitude data; and
a plurality of building element components representing space or equipment in a building, each building element component having boxel association data associating the building element with one of the plurality of georeferenced boxels.

2. The system of claim 1 wherein each of the plurality of georeferenced boxels represents exactly 1/10 of a second in a degree-minute-second geographical coordinate system.

3. The system of claim 1 wherein each of the plurality of georeferenced boxels comprises a cubic unit of about 10 feet by 10 feet by 10 feet (about 3 meters by 3 meters by 3 meters).

4. The system of claim 1 wherein each of the plurality of georeferenced boxels is represented by 10-characters using base64 encoding.

5. The system of claim 1 wherein the altitude component comprises an absolute altitude with respect to a ground floor of a building.

6. The system of claim 1 wherein the altitude component comprises a relative altitude which attaches a selected georeferenced boxel to a building floor on which the selected boxel is located.

7. The system of claim 1 wherein a selected building element component is associated with each georeferenced boxel in which at least one portion of the building element is located, up to a maximum of eight adjacent georeferenced boxels each sharing a common point of intersection.

8. The system of claim 1 wherein the association of a selected building element with one of the plurality of georeferenced boxels is time invariant.

9. The system of claim 1 wherein the association of a selected building element with one of the plurality of georeferenced boxels is invariant with respect to floor layout alteration.

10. A method of converting a two-dimensional (2D) building model to a three-dimensional (3D) georeferenced building model, comprising:
creating a 3D model by superimposing and stacking floor part perimeters of the 2D building model and adjusting building height;
determining a geographical position of the building represented by the 2D building model by obtaining georeferenced data corresponding to the building;
determining a global positioning system (GPS) coordinate corresponding to a selected point on the building;
extracting a transformation matrix to correlate the 2D building plan with the 3D model; and
determining a universal georeferenced representation of each element on the 2D plan based on the transformation matrix and on known information on relative position to the selected point on the building.

11. A method of converting a two-dimensional (2D) building model having 2D building plans to a three-dimensional (3D) georeferenced building model, comprising:
determining a transformation matrix to correlate the 2D building plans with the 3D model; and
determining a global georeferenced representation of each element on the 2D plan based on the transformation matrix and on known information on relative position to a selected point on the building.

12. The method of claim 11 further comprising:
superimposing and stacking floor part perimeters of the 2D building model and adjusting building height;
determining a geographical position of the building represented by the 2D building model by obtaining georeferenced data corresponding to the building;
determining a global positioning system (GPS) coordinate corresponding to the selected point on the building.

13. The method of claim 11 further comprising:
determining an associated boxel for a building element by transposing one of the vertices of the 2D plan to the 3D model using the transformation matrix; and
finding the equivalent of each 3D point in georeferenced coordinates by means of Haversine formulas.

14. The method of claim 13 further comprising creating a selectable plan by:
calculating the 4 edges and center of each boxel in the georeferenced environment;
converting the calculated boxel data into 3D data and 2D coordinates;
obtaining a bitmap image of a 2D plan and extrapolating each boxel edge to bitmap coordinates;
assigning a hyperlink to an area of the bitmap image corresponding to each boxel.

15. A computer-readable memory storing a global spatial georeferenced database for building and infrastructure comprising:
a plurality of georeferenced boxels, each of the plurality of georeferenced boxels providing a whole number georeferenced representation of a location on earth, each georeferenced boxel having a latitude component, a longitude component, and an altitude component; and
a plurality of building element components representing space or equipment in a building, each building element component being associated with one of the plurality of georeferenced boxels.

16. The computer-readable memory of claim 15 wherein each of the plurality of georeferenced boxels represents exactly 1/10 of a second in a degree-minute-second geographical coordinate system.

17. The computer-readable memory of claim 15 wherein each of the plurality of georeferenced boxels is represented by 10-characters using base64 encoding.

18. The computer-readable memory of claim 15 wherein a selected building element component is associated with each georeferenced boxel in which at least one portion of the building element is located, up to a maximum of eight adjacent georeferenced boxels each sharing a common point of intersection.

19. The computer-readable memory of claim 15 wherein the association of a selected building element with one of the plurality of georeferenced boxels is time invariant.

20. The computer-readable memory of claim 15 wherein the association of a selected building element with one of the plurality of georeferenced boxels is invariant with respect to floor layout alteration.
